(19) United States
(12) Patent Application Publication
(10) Pub. No.: US 2026/0064106 A1
(43) Pub. Date: Mar. 5, 2026

(54) BUILDING MANAGEMENT SYSTEM WITH DEVICE HEALTH INDICATORS

(71) Applicant: Tyco Fire & Security GmbH, Neuhausen am Rheinfall (CH)

(72) Inventors: Hunter R. Hobgood, Franklin, WI (US); Gregory B. Cebasek, New Berlin, WI (US); Abir Gon, Noida (IN); Robert H. Harland, Hendersonville, TN (US); Christopher A. Michalski, Saint Francis, WI (US); Christopher Piparo, Caledonia, WI (US); Paras Rajkumar Jatkar, Pune (IN)

(21) Appl. No.: 19/313,280

(22) Filed: Aug. 28, 2025

(30) Foreign Application Priority Data
Aug. 29, 2024 (IN) 202441065352

(51) Int. Cl. G05B 23/02; G05B 15/02

(52) U.S. Cl. CPC G05B 23/0224; G05B 15/02

(57) ABSTRACT

A building management system having a controller causes attribute data for one or more attributes of the building device to a first threshold and a second threshold. The controller determines that the building device has transitioned from a first status to a second status in response to the attribute data crossing the first threshold or the second threshold and generates one or more reasons for a transition from the first status to the second status by comparing the attribute data before crossing the first threshold or the second threshold with the attribute data at after crossing the first threshold or the second threshold. The controller initiates an automated action based on the one or more reasons for the transition to reduce the usage of the one or more hardware components of the building device or reduce the number of events experienced by the building device.

### CROSS-REFERENCE TO RELATED PATENT APPLICATIONS

This U.S. Patent application claims the benefit of and priority to India Provisional Application No. 20/244,1065352, filed Aug. 29, 2024, the entire contents of which is hereby incorporated herein by reference.

### BACKGROUND

A Building Management System (BMS) or Building Automation System (BAS) is, in general, a system of devices configured to control, monitor, and/or manage equipment in or around a building or building area. A BMS or BAS can include, for example, a HVAC system, a security system, a lighting system, a fire alerting system, any other system that is capable of managing building functions or devices, or any combination thereof. The terms BMS and BAS are used synonymously throughout the present disclosure.

A BAS may be controllable from a localized and/or an onsite premise. For example, a BAS may be controllable by an admin within a building. The admin may control the BAS using a computing device (e.g., a desktop computer).

### SUMMARY

One embodiment of the present disclosure relates to a building device. The building device includes a controller having one or more memory devices storing instructions thereon that, when executed by one or more processors, cause the one or more processors to compare attribute data for one or more attributes of the building device to a first threshold and a second threshold. The attribute data indicates a usage of one or more hardware components of the building device or a number of events experienced by the building device. The instructions cause the one or more processors to determine that the building device has transitioned from a first status to a second status in response to the attribute data crossing the first threshold or the second threshold. The instructions cause the one or more processors to generate one or more reasons for a transition from the first status to the second status by comparing the attribute data before crossing the first threshold or the second threshold and the attribute data after crossing the first threshold or the second threshold. The instructions cause the one or more processors to initiate an automated action based on the one or more reasons for the transition to reduce the usage of the one or more hardware components of the building device or reduce the number of events experienced by the building device in response to determining that the building device has transitioned from the first status to the second status.

Another embodiment relates to a building management system. The building management system includes one or more building devices and a controller. The controller includes one or more memory devices storing instructions thereon that, when executed by one or more processors, cause the one or more processors to compare attribute data for one or more attributes of the one or more building devices to a first threshold and a second threshold. The attribute data indicates a usage of one or more hardware components of the one or more building devices or a number of events experienced by the one or more building devices. The instructions cause the one or more processors to determine that the one or more building devices have transitioned from a first status to a second status in response to the attribute data crossing the first threshold or the second threshold. The instructions cause the one or more processors to generate a historical log of transitions between the first status and the second status based on attribute data associated with the one or more building devices. The instructions cause the one or more processors to cause a user device to display a user interface including one or more graphical representations of the historical log of transitions between the first status and the second status, the one or more graphical representations including user selectable elements.

Another embodiment relates to a method for dynamically updating and displaying attribute statuses associated with building devices of a building management system. The method includes comparing attribute data for one or more attributes of a building device to a first threshold and a second threshold. The attribute data indicates a usage of one or more hardware components of the building device or a number of events experienced by the building device. The method includes determining that the building device has transitioned from a first status to a second status in response to the attribute data crossing the first threshold or the second threshold. The method includes generating one or more reasons for a transition from the first status to the second status by comparing the attribute data before crossing the first threshold or the second threshold and the attribute data after crossing the first threshold or the second threshold. The method includes initiating an automated action based on the one or more reasons for the transition to reduce the usage of the one or more hardware components of the building device or reduce the number of events experienced by the building device in response to determining that the building device has transitioned from the first status to the second status.

Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

FIG. 1 is a perspective view drawing of a building equipped with a building automation system (BAS), according to an exemplary embodiment.

FIG. 2 is a block diagram illustrating the BAS of FIG. 1 in greater detail, showing a BAS controller in communication with several BAS subsystems and a plurality of BAS devices, according to an exemplary embodiment.

FIG. 3 is a block diagram illustrating the BAS controller of FIG. 2 in greater detail, according to an exemplary embodiment.

FIG. 4 is a block diagram of a building management system (BMS) which can be used to monitor and control the building of FIG. 1, according to some embodiments.

FIG. 5 is a block diagram of a building management system that includes one or more building devices, according to some embodiments.

FIG. 6 is a block diagram of a device health controller disposed on the building devices of FIG. 1, according to some embodiments.

FIG. 7 is a flow chart of a process for provided building device health statuses and analyses, according to some embodiments.

FIG. 8 is a view of an end user dashboard, according to some embodiments.

FIG. 9 is a log of building device health transitions, according to some embodiments.

FIG. 10 is a log of monitored attribute transitions, according to some embodiments.

FIG. 11 is a widget for additional monitored attributes, according to some embodiments.

### DETAILED DESCRIPTION

Following below are more detailed descriptions of various concepts related to, and implementations of systems, methods, and apparatuses for generating time varying performance indications for connected equipment. Before turning to the more detailed descriptions and figures, which illustrate the exemplary embodiments in detail, it should be understood that the application is not limited to the details or methodology set forth in the descriptions or illustrated in the figures. It should also be understood that the terminology is for the purpose of description only and should not be regarded as limiting in any way.

Systems, methods, and devices for dynamically updating and displaying attribute statuses associated with building devices of a building management system (BMS) are provided herein. The building devices may include a controller that compares attribute data for one or more attributes of the building device to a first threshold and a second threshold. The attribute data indicates a usage of one or more hardware components of the building device or a number of events experienced by the building device. The controller determines that the building device has transitioned from a first status to a second status in response to the attribute data crossing the first threshold or the second threshold. The controller generates one or more reasons for a transition from the first status to the second status by comparing the attribute data before crossing the first threshold or the second threshold with the attribute data after crossing the first threshold or the second threshold. The controller initiates an automated action based on the one or more reasons for the transition to reduce the usage of the one or more hardware components of the building device or reduce the number of events experienced by the building device in response to determining that the building device has transitioned from the first status to the second status. In some examples, the controller generates a historical log of transitions between the first status and the second status and causes a user device to display a user interface including a graphical representation the historical log.

Advantageously, the statuses (i.e., status indicators) and history log provide a view into the operational health of building devices, allowing users to assess and diagnose potential issues within the building management system (BMS). In some examples, the building devices and the status indicators offer real-time visibility into device performance, displaying color-coded health statuses such as green, yellow, and red, which correspond to various levels of operational efficiency and risk. Beneficially, these indicators facilitate prompt action by highlighting device attributes that require attention. Furthermore, the incorporation of a historical log enhances the diagnostic capabilities of the BMS by capturing each status transition and storing it chronologically. This log serves as a tool for ongoing device performance analysis, allowing facility managers to track trends, identify recurring issues, and implement maintenance strategies.

The BMS may initiate automated processes in response to status transitions. For instance, automated actions such as terminating processes to reduce CPU load or adjusting network settings to improve communication quality can be triggered automatically when certain attribute thresholds are met. These pre-defined responses allow the BMS to proactively manage device health, without or with less need for manual oversight. Beneficially, this automation mitigates or reduces the likelihood of building device failures by addressing issues as they emerge. In some examples, the automated actions can be or include transmitting a notification of a change in status of an attribute to a user device and/or operating a user device or building device to output an alarm. Such notifications may include recommendations for personnel to address an attribute falling within a predefined threshold range. These and other benefits are described more fully herein.

### Building Management System

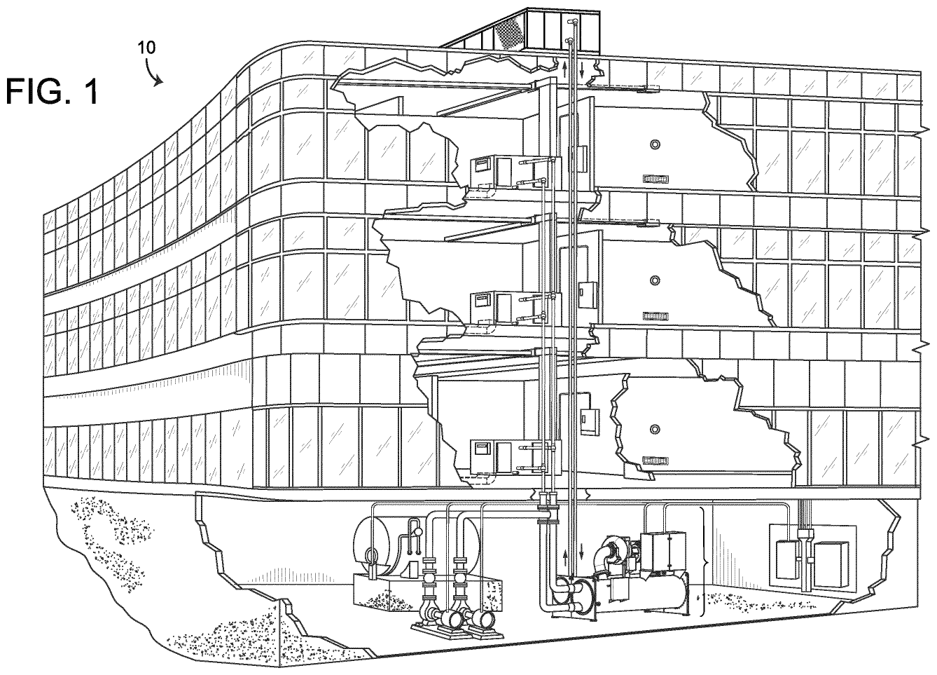

Referring now to FIG. 1, a perspective view of a building 10 is shown, according to an example embodiment. A building automation system (BAS)/building management system (DMS) serves building 10. The BAS for building 10 may include any number or type of devices that serve building 10. For example, each floor may include one or more security devices, video surveillance cameras, fire detectors, smoke detectors, lighting systems, HVAC systems, or other building systems or devices. In modern BAS devices, BAS devices can exist on different networks within the building 10 (e.g., one or more wireless networks, one or more wired networks, etc.) and yet serve the same building space or control loop. For example, BAS devices may be connected to different communications networks or field controllers even if the devices serve the same area (e.g., floor, conference room, building zone, tenant area, etc.) or purpose (e.g., security, ventilation, cooling, heating, etc.).

BAS devices may collectively or individually be referred to as building equipment. Building equipment may include any number or type of BAS devices within or around building 10. For example, building equipment may include controllers, chillers, rooftop units, fire and security systems, elevator systems, thermostats, lighting, serviceable equipment (e.g., vending machines), and/or any other type of equipment that can be used to control, automate, or otherwise contribute to an environment, state, or condition of building 10. The terms “BAS devices,” “BAS device,” and “building equipment” are used interchangeably throughout this disclosure.

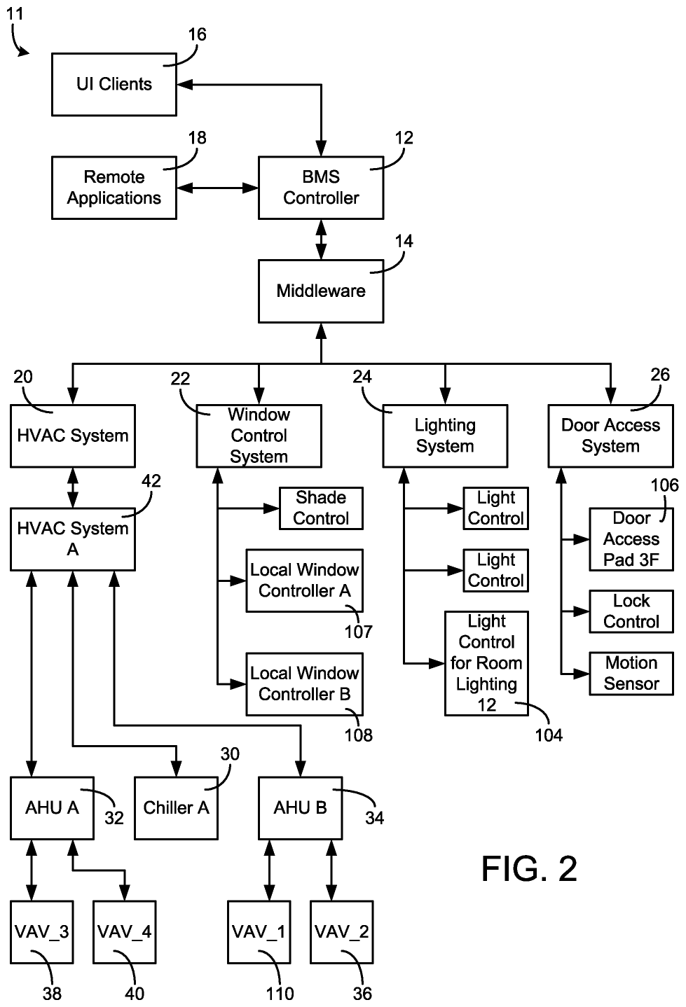

Referring now to FIG. 2, a block diagram of a BAS 11 for building 10 is shown, according to an example embodiment. BAS 11 is shown to include a plurality of BAS subsystems 20-26. BAS subsystems 20-26 are connected to a plurality of BAS devices and makes data points for varying connected devices available to upstream BAS controller 12. Additionally, BAS subsystems 20-26 may encompass other lower-level subsystems. For example, an HVAC system may be broken down further as “HVAC system A,” “HVAC system B,” etc. In some buildings, multiple HVAC systems or subsystems may exist in parallel and may not be a part of the same HVAC system 20.

As shown in FIG. 2, BAS 11 may include a HVAC system 20. HVAC system 20 may control HVAC operations building 10. HVAC system 20 is shown to include a lower-level HVAC system 42 (named “HVAC system A”). HVAC system 42 may control HVAC operations for a specific floor or zone of building 10. HVAC system 42 may be connected to air handling units (AHUs) 32, 34 (named “AHU A” and “AHU B,” respectively, in BAS 11). AHU 32 may serve variable air volume (VAV) boxes 38, 40 (named “VAV_3” and “VAV_4” in BAS 11). Likewise, AHU 34 may serve VAV boxes 36 and 110 (named “VAV_2” and “VAV_1”). HVAC system 42 may also include chiller 30 (named “Chiller A” in BAS 11). Chiller 30 may provide chilled fluid to AHU 32 and/or to AHU 34. HVAC system 42 may receive data (i.e., BAS inputs such as temperature sensor readings, damper positions, temperature setpoints, etc.) from AHUs 32, 34. HVAC system 42 may provide such BAS inputs to HVAC system 20 and on to middleware 14 and BAS controller 12. Similarly, other BAS subsystems may receive inputs from other building devices or objects and provide the received inputs to BAS controller 12 (e.g., via middleware 14).

Middleware 14 may include services that allow interoperable communication to, from, or between disparate BAS subsystems 20-26 of BAS 11 (e.g., HVAC systems from different manufacturers, HVAC systems that communicate according to different protocols, security/fire systems, IT resources, door access systems, etc.). Middleware 14 may be, for example, an EnNet server sold by Johnson Controls, Inc. While middleware 14 is shown as separate from BAS controller 12, middleware 14 and BAS controller 12 may be integrated in some embodiments. For example, middleware 14 may be a part of BAS controller 12.

Still referring to FIG. 2, window control system 22 may receive shade control information from one or more shade controls, ambient light level information from one or more light sensors, and/or other BAS inputs (e.g., sensor information, setpoint information, current state information, etc.) from downstream devices. Window control system 22 may include window controllers 107, 108 (e.g., named “local window controller A” and “local window controller B,” respectively, in BAS 11). Window controllers 107, 108 control the operation of subsets of window control system 22. For example, window controller 108 may control window blind or shade operations for a given room, floor, or building 10 in the BAS.

Lighting system 24 may receive lighting related information from a plurality of downstream light controls (e.g., from room lighting 104). Door access system 26 may receive lock control, motion, state, or other door related information from a plurality of downstream door controls. Door access system 26 is shown to include door access pad 106 (named “Door Access Pad 3F”), which may grant or deny access to a building space (e.g., a floor, a conference room, an office, etc.) based on whether valid user credentials are scanned or entered (e.g., via a keypad, via a badge-scanning pad, etc.).

BAS subsystems 20-26 may be connected to BAS controller 12 via middleware 14 and may be configured to provide BAS controller 12 with BAS inputs from various BAS subsystems 20-26 and their varying downstream devices. BAS controller 12 may be configured to make differences in building subsystems transparent at the human-machine interface or client interface level (e.g., for connected or hosted user interface (UI) clients 16, remote applications 18, etc.). BAS controller 12 may be configured to describe or model different building devices and building subsystems using common or unified objects (e.g., software objects stored in memory) to help provide the transparency. Software equipment objects may allow developers to write applications capable of monitoring and/or controlling various types of building equipment regardless of equipment-specific variations (e.g., equipment model, equipment manufacturer, equipment version, etc.). Software building objects may allow developers to write applications capable of monitoring and/or controlling building zones on a zone-by-zone level regardless of the building subsystem makeup.

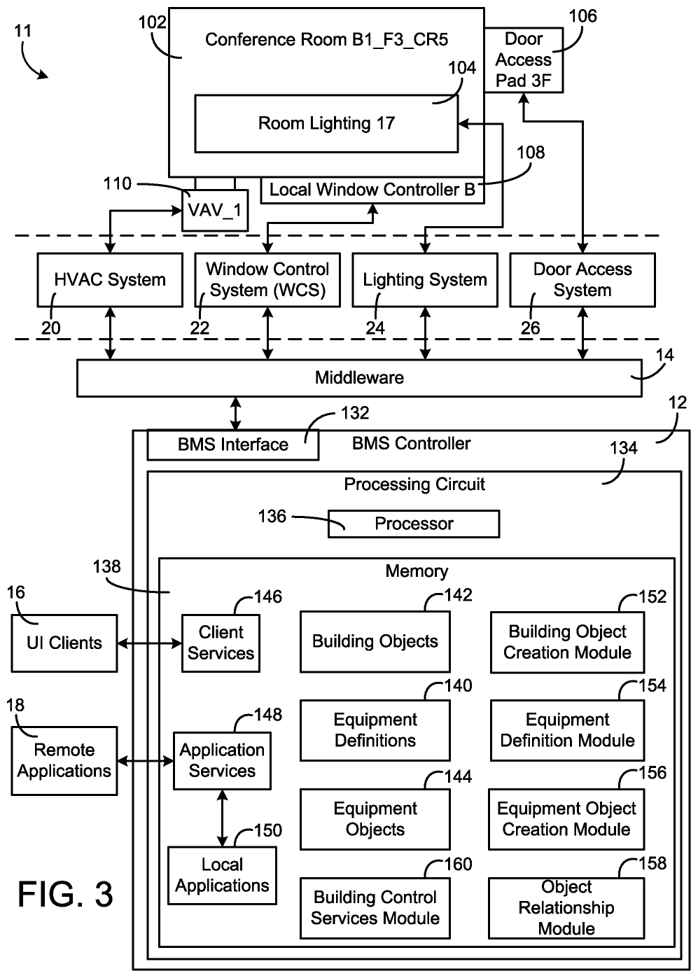

Referring now to FIG. 3, a block diagram illustrating a portion of BAS 11 in greater detail is shown, according to an example embodiment. Particularly, FIG. 3 illustrates a portion of BAS 11 that services a conference room 102 of building 10 (named “B1_F3_CR5”). Conference room 102 may be affected by many different building devices connected to many different BAS subsystems. For example, conference room 102 includes, or is otherwise affected by VAV box 110, window controller 108 (e.g., a blind controller), room lighting 104 (named “Room Lighting 17”), and a door access pad 106.

Each of the building devices shown at the top of FIG. 3 may include local control circuitry configured to provide signals to their supervisory controllers or more generally to the BAS subsystems 20-26. The local control circuitry of the building devices shown at the top of FIG. 3 may also be configured to receive and respond to control signals, commands, setpoints, or other data from their supervisory controllers. For example, the local control circuitry of VAV box 110 may include circuitry that affects an actuator in response to control signals received from a field controller that is a part of HVAC system 20. Window controller 108 may include circuitry that affects windows or blinds in response to control signals received from a field controller that is part of window control system (WCS) 22. Room lighting 104 may include circuitry that affects the lighting in response to control signals received from a field controller that is part of lighting system 24. Door access pad 106 may include circuitry that affects door access (e.g., locking or unlocking the door) in response to control signals received from a field controller that is part of door access system 26.

Still referring to FIG. 3, BAS controller 12 is shown to include a BAS interface 132 in communication with middleware 14. In some embodiments, BAS interface 132 is a communications interface. For example, BAS interface 132 may include wired or wireless interfaces (e.g., jacks, antennas, transmitters, receivers, transceivers, wire terminals, etc.) for conducting data communications with various systems, devices, or networks. BAS interface 132 can include an Ethernet card and port for sending and receiving data via an Ethernet-based communications network. In another example, BAS interface 132 includes a Wi-Fi transceiver for communicating via a wireless communications network. BAS interface 132 may be configured to communicate via local area networks or wide area networks (e.g., the Internet, a building WAN, etc.).

In some embodiments, BAS interface 132 and/or middleware 14 includes an application gateway configured to receive input from applications running on client devices. For example, BAS interface 132 and/or middleware 14 may include one or more wireless transceivers (e.g., a Wi-Fi transceiver, a Bluetooth transceiver, an NFC transceiver, or a cellular transceiver, etc.) for communicating with client devices. BAS interface 132 may be configured to receive building management inputs from middleware 14 or directly from one or more BAS subsystems 20-26. BAS interface 132 and/or middleware 14 can include any number of software buffers, queues, listeners, filters, translators, or other communications-supporting services.

Still referring to FIG. 3, BAS controller 12 is shown to include a processing circuit 134 including a processor 136 and memory 138. Processor 136 may be a general purpose or specific purpose processor, an application specific integrated circuit (ASIC), one or more field programmable gate arrays (FPGAs), a group of processing components, or other suitable processing components. Processor 136 is configured to execute computer code or instructions stored in memory 138 or received from other computer readable media (e.g., CDROM, network storage, a remote server, etc.).

Memory 138 may include one or more devices (e.g., memory units, memory devices, storage devices, etc.) for storing data and/or computer code for completing and/or facilitating the various processes described in the present disclosure. Memory 138 may include random access memory (RAM), read-only memory (ROM), hard drive storage, temporary storage, non-volatile memory, flash memory, optical memory, or any other suitable memory for storing software objects and/or computer instructions. Memory 138 may include database components, object code components, script components, or any other type of information structure for supporting the various activities and information structures described in the present disclosure. Memory 138 may be communicably connected to processor 136 via processing circuit 134 and may include computer code for executing (e.g., by processor 136) one or more processes described herein. When processor 136 executes instructions stored in memory 138 for completing the various activities described herein, processor 136 generally configures BAS controller 12 (and more particularly processing circuit 134) to complete such activities.

Still referring to FIG. 3, memory 138 is shown to include building objects 142. In some embodiments, BAS controller 12 uses building objects 142 to group otherwise ungrouped or unassociated devices so that the group may be addressed or handled by applications together and in a consistent manner (e.g., a single user interface for controlling all of the BAS devices that affect a particular building zone or room). Building objects can apply to spaces of any granularity. For example, a building object can represent an entire building, a floor of a building, or individual rooms on each floor. In some embodiments, BAS controller 12 creates and/or stores a building object in memory 138 for each zone or room of building 10. Building objects 142 can be accessed by UI clients 16 and remote applications 18 to provide a comprehensive user interface for controlling and/or viewing information for a particular building zone. Building objects 142 may be created by building object creation module 152 and associated with equipment objects by object relationship module 158, described in greater detail below.

Still referring to FIG. 3, memory 138 is shown to include equipment definitions 140. Equipment definitions 140 stores the equipment definitions for various types of building equipment. Each equipment definition may apply to building equipment of a different type. For example, equipment definitions 140 may include different equipment definitions for variable air volume modular assemblies (VMAs), fan coil units, air handling units (AHUs), lighting fixtures, water pumps, and/or other types of building equipment.

Equipment definitions 140 define the types of data points that are generally associated with various types of building equipment. For example, an equipment definition for VMA may specify data point types such as room temperature, damper position, supply air flow, and/or other types of data measured or used by the VMA. Equipment definitions 140 allow for the abstraction (e.g., generalization, normalization, broadening, etc.) of equipment data from a specific BAS device so that the equipment data can be applied to a room or space.

Each of equipment definitions 140 may include one or more point definitions. Each point definition may define a data point of a particular type and may include search criteria for automatically discovering and/or identifying data points that satisfy the point definition. An equipment definition can be applied to multiple pieces of building equipment of the same general type (e.g., multiple different VMA controllers). When an equipment definition is applied to a BAS device, the search criteria specified by the point definitions can be used to automatically identify data points provided by the BAS device that satisfy each point definition.

In some embodiments, equipment definitions 140 define data point types as generalized types of data without regard to the model, manufacturer, vendor, or other differences between building equipment of the same general type. The generalized data points defined by equipment definitions 140 allows each equipment definition to be referenced by or applied to multiple different variants of the same type of building equipment.

In some embodiments, equipment definitions 140 facilitate the presentation of data points in a consistent and user-friendly manner. For example, each equipment definition may define one or more data points that are displayed via a user interface. The displayed data points may be a subset of the data points defined by the equipment definition.

In some embodiments, equipment definitions 140 specify a system type (e.g., HVAC, lighting, security, fire, etc.), a system sub-type (e.g., terminal units, air handlers, central plants), and/or data category (e.g., critical, diagnostic, operational) associated with the building equipment defined by each equipment definition. Specifying such attributes of building equipment at the equipment definition level allows the attributes to be applied to the building equipment along with the equipment definition when the building equipment is initially defined. Building equipment can be filtered by various attributes provided in the equipment definition to facilitate the reporting and management of equipment data from multiple building systems.

Equipment definitions 140 can be automatically created by abstracting the data points provided by archetypal controllers (e.g., typical or representative controllers) for various types of building equipment. In some embodiments, equipment definitions 140 are created by equipment definition module 154, described in greater detail below.

Still referring to FIG. 3, memory 138 is shown to include equipment objects 144. Equipment objects 144 may be software objects that define a mapping between a data point type (e.g., supply air temperature, room temperature, damper position) and an actual data point (e.g., a measured or calculated value for the corresponding data point type) for various pieces of building equipment. Equipment objects 144 may facilitate the presentation of equipment-specific data points in an intuitive and user-friendly manner by associating each data point with an attribute identifying the corresponding data point type. The mapping provided by equipment objects 144 may be used to associate a particular data value measured or calculated by BAS 11 with an attribute that can be displayed via a user interface.

Equipment objects 144 can be created (e.g., by equipment object creation module 156) by referencing equipment definitions 140. For example, an equipment object can be created by applying an equipment definition the data points provided by a BAS device. The search criteria included in an equipment definition can be used to identify data points of the building equipment that satisfy the point definitions. A data point that satisfies a point definition can be mapped to an attribute of the equipment object corresponding to the point definition.

Each equipment object may include one or more attributes defined by the point definitions of the equipment definition used to create the equipment object. For example, an equipment definition which defines the attributes “Occupied Command,” “Room Temperature,” and “Damper Position” may result in an equipment object being created with the same attributes. The search criteria provided by the equipment definition are used to identify and map data points associated with a particular BAS device to the attributes of the equipment object. The creation of equipment objects is described in greater detail below with reference to equipment object creation module 156.

Equipment objects 144 may be related with each other and/or with building objects 142. Causal relationships can be established between equipment objects to link equipment objects to each other. For example, a causal relationship can be established between a VMA and an AHU which provides airflow to the VMA. Causal relationships can also be established between equipment objects 144 and building objects 142. For example, equipment objects 144 can be associated with building objects 142 representing particular rooms or zones to indicate that the equipment object serves that room or zone. Relationships between objects are described in greater detail below with reference to object relationship module 158.

Still referring to FIG. 3, memory 138 is shown to include client services 146 and application services 148. Client services 146 may be configured to facilitate interaction and/or communication between BAS controller 12 and various internal or external clients or applications. For example, client services 146 may include web services or application programming interfaces available for communication by UI clients 16 and remote applications 18 (e.g., applications running on a mobile device, energy monitoring applications, applications allowing a user to monitor the performance of the BAS, automated fault detection and diagnostics systems, etc.). Application services 148 may facilitate direct or indirect communications between remote applications 18, local applications 150, and BAS controller 12. For example, application services 148 may allow BAS controller 12 to communicate (e.g., over a communications network) with remote applications 18 running on mobile devices and/or with other BAS controllers.

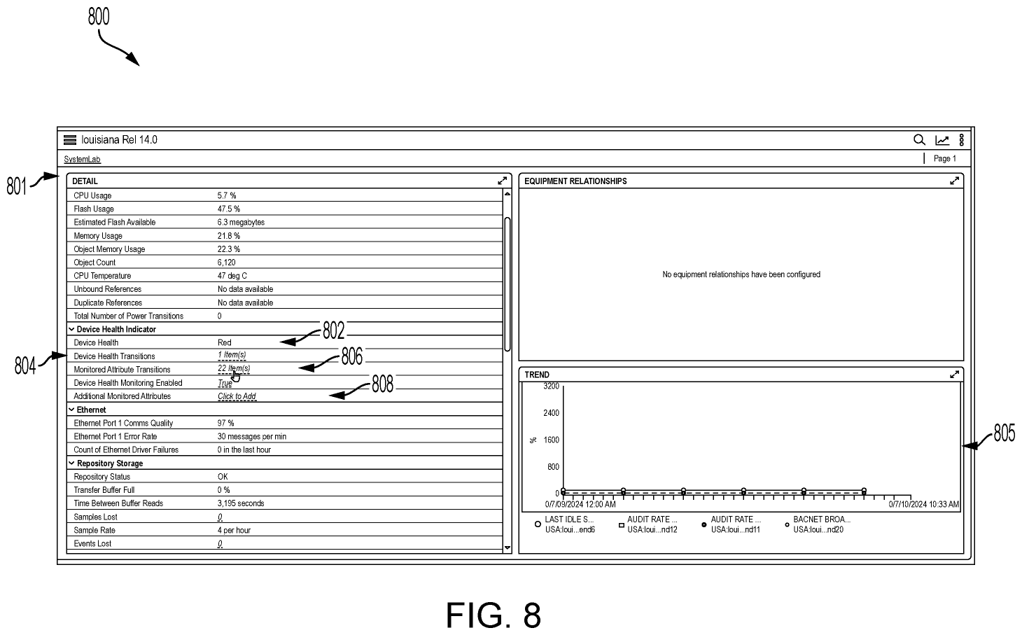

In some embodiments, application services 148 facilitate an applications gateway for conducting electronic data communications with UI clients 16 and/or remote applications 18. For example, application services 148 may be configured to receive communications from mobile devices and/or BAS devices. Client services 146 may provide client devices with a graphical user interface that consumes data points and/or display data defined by equipment definitions 140 and mapped by equipment objects 144. Various user interfaces provided by client services 146 are described in greater detail with reference to FIGS. 8-11.

Still referring to FIG. 3, memory 138 is shown to include a building object creation module 152. Building object creation module 152 may be configured to create the building objects stored in building objects 142. Building object creation module 152 may create a software building object for various spaces within building 10. Building object creation module 152 can create a building object for a space of any size or granularity. For example, building object creation module 152 can create a building object representing an entire building, a floor of a building, or individual rooms on each floor. In some embodiments, building object creation module 152 creates and/or stores a building object in memory 138 for each zone or room of building 10.

The building objects created by building object creation module 152 can be accessed by UI clients 16 and remote applications 18 to provide a comprehensive user interface for controlling and/or viewing information for a particular building zone. Building objects 142 can group otherwise ungrouped or unassociated devices so that the group may be addressed or handled by applications together and in a consistent manner (e.g., a single user interface for controlling all of the BAS devices that affect a particular building zone or room). In some embodiments, building object creation module 152 uses the systems and methods described in U.S. patent application Ser. No. 12/887,390, filed Sep. 21, 2010, for creating software defined building objects.

In some embodiments, building object creation module 152 provides a user interface for guiding a user through a process of creating building objects. For example, building object creation module 152 may provide a user interface to client devices (e.g., via client services 146) that allows a new space to be defined. In some embodiments, building object creation module 152 defines spaces hierarchically. For example, the user interface for creating building objects may prompt a user to create a space for a building, for floors within the building, and/or for rooms or zones within each floor.

In some embodiments, building object creation module 152 creates building objects automatically or semi-automatically. For example, building object creation module 152 may automatically define and create building objects using data imported from another data source (e.g., user view folders, a table, a spreadsheet, etc.). In some embodiments, building object creation module 152 references an existing hierarchy for BAS 11 to define the spaces within building 10. For example, BAS 11 may provide a listing of controllers for building 10 (e.g., as part of a network of data points) that have the physical location (e.g., room name) of the controller in the name of the controller itself. Building object creation module 152 may extract room names from the names of BAS controllers defined in the network of data points and create building objects for each extracted room. Building objects may be stored in building objects 142.

Still referring to FIG. 3, memory 138 is shown to include an equipment definition module 154. Equipment definition module 154 may be configured to create equipment definitions for various types of building equipment and to store the equipment definitions in equipment definitions 140. In some embodiments, equipment definition module 154 creates equipment definitions by abstracting the data points provided by archetypal controllers (e.g., typical or representative controllers) for various types of building equipment. For example, equipment definition module 154 may receive a user selection of an archetypal controller via a user interface. The archetypal controller may be specified as a user input or selected automatically by equipment definition module 154. In some embodiments, equipment definition module 154 selects an archetypal controller for building equipment associated with a terminal unit such as a VMA.

Equipment definition module 154 may identify one or more data points associated with the archetypal controller. Identifying one or more data points associated with the archetypal controller may include accessing a network of data points provided by BAS 11. The network of data points may be a hierarchical representation of data points that are measured, calculated, or otherwise obtained by various BAS devices. BAS devices may be represented in the network of data points as nodes of the hierarchical representation with associated data points depending on each BAS device. Equipment definition module 154 may find the node corresponding to the archetypal controller in the network of data points and identify one or more data points which depend on the archetypal controller node.

Equipment definition module 154 may generate a point definition for each identified data point of the archetypal controller. Each point definition may include an abstraction of the corresponding data point that is applicable to multiple different controllers for the same type of building equipment. For example, an archetypal controller for a particular VMA (i.e., “VMA-20”) may be associated with an equipment-specific data point such as “VMA-20.DPR-POS” (i.e., the damper position of VMA-20) and/or “VMA-20.SUP-FLOW” (i.e., the supply air flow rate through VMA-20). Equipment definition module 154 abstract the equipment-specific data points to generate abstracted data point types that are generally applicable to other equipment of the same type. For example, equipment definition module 154 may abstract the equipment-specific data point “VMA-20.DPR-POS” to generate the abstracted data point type “DPR-POS” and may abstract the equipment-specific data point “VMA-20.SUP-FLOW” to generate the abstracted data point type “SUP-FLOW.” Advantageously, the abstracted data point types generated by equipment definition module 154 can be applied to multiple different variants of the same type of building equipment (e.g., VMAs from different manufacturers, VMAs having different models or output data formats, etc.).

In some embodiments, equipment definition module 154 generates a user-friendly label for each point definition. The user-friendly label may be a plain text description of the variable defined by the point definition. For example, equipment definition module 154 may generate the label “Supply Air Flow” for the point definition corresponding to the abstracted data point type “SUP-FLOW” to indicate that the data point represents a supply air flow rate through the VMA. The labels generated by equipment definition module 154 may be displayed in conjunction with data values from BAS devices as part of a user-friendly interface.

In some embodiments, equipment definition module 154 generates search criteria for each point definition. The search criteria may include one or more parameters for identifying another data point (e.g., a data point associated with another controller of BAS 11 for the same type of building equipment) that represents the same variable as the point definition. Search criteria may include, for example, an instance number of the data point, a network address of the data point, and/or a network point type of the data point.

In some embodiments, search criteria includes a text string abstracted from a data point associated with the archetypal controller. For example, equipment definition module 154 may generate the abstracted text string “SUP-FLOW” from the equipment-specific data point “VMA-20.SUP-FLOW.” Advantageously, the abstracted text string matches other equipment-specific data points corresponding to the supply air flow rates of other BAS devices (e.g., “VMA-18.SUP-FLOW,” “SUP-FLOW.VMA-01,” etc.). Equipment definition module 154 may store a name, label, and/or search criteria for each point definition in memory 138.

Equipment definition module 154 may use the generated point definitions to create an equipment definition for a particular type of building equipment (e.g., the same type of building equipment associated with the archetypal controller). The equipment definition may include one or more of the generated point definitions. Each point definition defines a potential attribute of BAS devices of the particular type and provides search criteria for identifying the attribute among other data points provided by such BAS devices.

In some embodiments, the equipment definition created by equipment definition module 154 includes an indication of display data for BAS devices that reference the equipment definition. Display data may define one or more data points of the BAS device that will be displayed via a user interface. In some embodiments, display data are user defined. For example, equipment definition module 154 may prompt a user to select one or more of the point definitions included in the equipment definition to be represented in the display data. Display data may include the user-friendly label (e.g., “Damper Position”) and/or short name (e.g., “DPR-POS”) associated with the selected point definitions.

In some embodiments, equipment definition module 154 provides a visualization of the equipment definition via a graphical user interface. The visualization of the equipment definition may include a point definition portion which displays the generated point definitions, a user input portion configured to receive a user selection of one or more of the point definitions displayed in the point definition portion, and/or a display data portion which includes an indication of an abstracted data point corresponding to each of the point definitions selected via the user input portion. The visualization of the equipment definition can be used to add, remove, or change point definitions and/or display data associated with the equipment definitions.

Equipment definition module 154 may generate an equipment definition for each different type of building equipment in BAS 11 (e.g., VMAs, chillers, AHUs, etc.). Equipment definition module 154 may store the equipment definitions in a data storage device (e.g., memory 138, equipment definitions 140, an external or remote data storage device, etc.).

Still referring to FIG. 3, memory 138 is shown to include an equipment object creation module 156. Equipment object creation module 156 may be configured to create equipment objects for various BAS devices. In some embodiments, equipment object creation module 156 creates an equipment object by applying an equipment definition the data points provided by a BAS device. For example, equipment object creation module 156 may receive an equipment definition created by equipment definition module 154. Receiving an equipment definition may include loading or retrieving the equipment definition from a data storage device.

In some embodiments, equipment object creation module 156 determines which of a plurality of equipment definitions to retrieve based on the type of BAS device used to create the equipment object. For example, if the BAS device is a VMA, equipment object creation module 156 may retrieve the equipment definition for VMAs; whereas if the BAS device is a chiller, equipment object creation module 156 may retrieve the equipment definition for chillers. The type of BAS device to which an equipment definition applies may be stored as an attribute of the equipment definition. Equipment object creation module 156 may identify the type of BAS device being used to create the equipment object and retrieve the corresponding equipment definition from the data storage device.

In other embodiments, equipment object creation module 156 receives an equipment definition prior to selecting a BAS device. Equipment object creation module 156 may identify a BAS device of BAS 11 to which the equipment definition applies. For example, equipment object creation module 156 may identify a BAS device that is of the same type of building equipment as the archetypal BAS device used to generate the equipment definition. In various embodiments, the BAS device used to generate the equipment object may be selected automatically (e.g., by equipment object creation module 156), manually (e.g., by a user), or semi-automatically (e.g., by a user in response to an automated prompt from equipment object creation module 156).

In some embodiments, equipment object creation module 156 creates an equipment discovery table based on the equipment definition. For example, equipment object creation module 156 may create an equipment discovery table having attributes (e.g., columns) corresponding to the variables defined by the equipment definition (e.g., a damper position attribute, a supply air flow rate attribute, etc.). Each column of the equipment discovery table may correspond to a point definition of the equipment definition. The equipment discovery table may have columns that are categorically defined (e.g., representing defined variables) but not yet mapped to any particular data points.

Equipment object creation module 156 may use the equipment definition to automatically identify one or more data points of the selected BAS device to map to the columns of the equipment discovery table. Equipment object creation module 156 may search for data points of the BAS device that satisfy one or more of the point definitions included in the equipment definition. In some embodiments, equipment object creation module 156 extracts a search criterion from each point definition of the equipment definition. Equipment object creation module 156 may access a data point network of the building automation system to identify one or more data points associated with the selected BAS device. Equipment object creation module 156 may use the extracted search criterion to determine which of the identified data points satisfy one or more of the point definitions.

In some embodiments, equipment object creation module 156 automatically maps (e.g., links, associates, relates, etc.) the identified data points of selected BAS device to the equipment discovery table. A data point of the selected BAS device may be mapped to a column of the equipment discovery table in response to a determination by equipment object creation module 156 that the data point satisfies the point definition (e.g., the search criteria) used to generate the column. For example, if a data point of the selected BAS device has the name “VMA-18.SUP-FLOW” and a search criterion is the text string “SUP-FLOW,” equipment object creation module 156 may determine that the search criterion is met. Accordingly, equipment object creation module 156 may map the data point of the selected BAS device to the corresponding column of the equipment discovery table.

Advantageously, equipment object creation module 156 may create multiple equipment objects and map data points to attributes of the created equipment objects in an automated fashion (e.g., without human intervention, with minimal human intervention, etc.). The search criteria provided by the equipment definition facilitate the automatic discovery and identification of data points for a plurality of equipment object attributes. Equipment object creation module 156 may label each attribute of the created equipment objects with a device-independent label derived from the equipment definition used to create the equipment object. The equipment objects created by equipment object creation module 156 can be viewed (e.g., via a user interface) and/or interpreted by data consumers in a consistent and intuitive manner regardless of device-specific differences between BAS devices of the same general type. The equipment objects created by equipment object creation module 156 may be stored in equipment objects 144.

Still referring to FIG. 3, memory 138 is shown to include an object relationship module 158. Object relationship module 158 may be configured to establish relationships between equipment objects 144. In some embodiments, object relationship module 158 establishes causal relationships between equipment objects 144 based on the ability of one BAS device to affect another BAS device. For example, object relationship module 158 may establish a causal relationship between a terminal unit (e.g., a VMA) and an upstream unit (e.g., an AHU, a chiller, etc.) which affects an input provided to the terminal unit (e.g., air flow rate, air temperature, etc.).

Object relationship module 158 may establish relationships between equipment objects 144 and building objects 142 (e.g., space objects, spaces, etc.). For example, object relationship module 158 may associate equipment objects 144 with building objects 142 representing particular rooms or zones to indicate that the equipment object serves that room or zone. In some embodiments, object relationship module 158 provides a user interface through which a user can define relationships between equipment objects 144 and building objects 142. For example, a user can assign relationships in a “drag and drop” fashion by dragging and dropping a building object and/or an equipment object into a “serving” cell of an equipment object provided via the user interface to indicate that the BAS device represented by the equipment object serves a particular space or another BAS device.

Still referring to FIG. 3, memory 138 is shown to include a building control services module 160. Building control services module 160 may be configured to automatically control BAS 11 and the various subsystems thereof. Building control services module 160 may utilize closed loop control, feedback control, PI control, model predictive control, or any other type of automated building control methodology to control the environment (e.g., a variable state or condition) within building 10.

Building control services module 160 may receive inputs from sensory devices (e.g., temperature sensors, pressure sensors, flow rate sensors, humidity sensors, electric current sensors, cameras, radio frequency sensors, microphones, etc.), user input devices (e.g., computer terminals, client devices, user devices, etc.) or other data input devices via BAS interface 132. Building control services module 160 may apply the various inputs to a building energy use model and/or a control algorithm to determine an output for one or more building control devices (e.g., dampers, air handling units, chillers, boilers, fans, pumps, etc.) in order to affect a variable state or condition within building 10 (e.g., zone temperature, humidity, air flow rate, etc.).

In some embodiments, building control services module 160 is configured to control the environment of building 10 on a zone-individualized level. For example, building control services module 160 may control the environment of two or more different building zones using different setpoints, constraints, control methodology, and/or control parameters. Building control services module 160 may operate BAS 11 to maintain building conditions (e.g., temperature, humidity, air quality, etc.) within a setpoint range, to optimize energy performance (e.g., to minimize energy consumption, to minimize energy cost, etc.), and/or to satisfy any constraint or combination of constraints as may be desirable for various implementations.

In some embodiments, building control services module 160 uses the location of various BAS devices to translate an input received from a building system into an output or control signal for the building system. Building control services module 160 may receive location information for BAS devices from building object creation module 152. In some embodiments, building control services module 160 automatically sets or recommends control parameters for the BAS devices based on the locations of the BAS devices. For example, building control services module 160 may automatically set a flow rate setpoint for a VAV box based on the size of the building zone in which the VAV box is located.

Building control services module 160 may determine which of a plurality of sensors to use in conjunction with a feedback control loop based on the locations of the sensors within building 10. For example, building control services module 160 may use a signal from a temperature sensor located in a building zone as a feedback signal for controlling the temperature of the building zone in which the temperature sensor is located.

In some embodiments, building control services module 160 automatically generates control algorithms for a controller or a building zone based on the location of the zone in the building 10. For example, building control services module 160 may be configured to predict a change in demand resulting from sunlight entering through windows based on the orientation of the building and the locations of the building zones (e.g., east-facing, west-facing, perimeter zones, interior zones, etc.).

Building control services module 160 may use zone location information and interactions between adjacent building zones (rather than considering each zone as an isolated system) to more efficiently control the temperature and/or airflow within building 10. For control loops that are conducted at a larger scale (i.e., floor level) building control services module 160 may use the location of each building zone and/or BAS device to coordinate control functionality between building zones. For example, building control services module 160 may consider heat exchange and/or air exchange between adjacent building zones as a factor in determining an output control signal for the building zones.

In some embodiments, building control services module 160 is configured to optimize the energy efficiency of building 10 using the locations of various BAS devices and the control parameters associated therewith. Building control services module 160 may be configured to achieve control setpoints using building equipment with a relatively lower energy cost (e.g., by causing airflow between connected building zones) in order to reduce the loading on building equipment with a relatively higher energy cost (e.g., chillers and roof top units). For example, building control services module 160 may be configured to move warmer air from higher elevation zones to lower elevation zones by establishing pressure gradients between connected building zones.

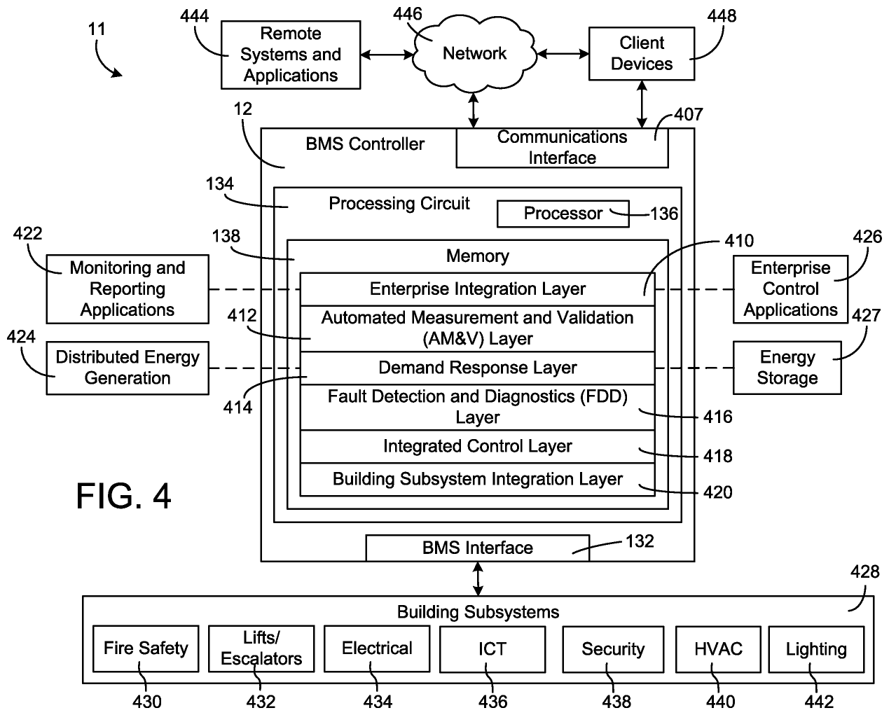

Referring now to FIG. 4, a block diagram of a building automation system (BAS) 400 is shown, according to an exemplary embodiment. BAS 11 may be implemented in building 10 to automatically monitor and control various building functions. BAS 11 is shown to include BAS controller 12 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 may include at least one of the various building systems and/or building subsystems described herein.

Each of building subsystems 428 may include any number of devices, controllers, and connections for completing its individual functions and control activities. For example, HVAC subsystem 440 may include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 may include any number of light fixtures, ballasts, lighting sensors, dimmers, or other devices configured to controllably adjust the amount of light provided to a building space. Security subsystem 438 may include occupancy sensors, video surveillance cameras, digital video recorders, video processing servers, intrusion detection devices, access control devices and servers, or other security-related devices.

Still referring to FIG. 4, BAS controller 12 is shown to include a communications interface 407 and a BAS interface 409. Interface 407 may facilitate communications between BAS controller 12 and external applications (e.g., monitoring and reporting applications 422, enterprise control applications 426, remote systems and applications 444, applications residing on client devices 448, etc.) for allowing user control, monitoring, and adjustment to BAS controller 12 and/or subsystems 428. Interface 407 may also facilitate communications between BAS controller 12 and client devices 448. BAS interface 409 may facilitate communications between BAS controller 12 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 may be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 may include cellular or mobile phone communications transceivers. In one embodiment, communications interface 407 is a power line communications interface and BAS interface 409 is an Ethernet interface. In other embodiments, both communications interface 407 and BAS interface 409 are Ethernet interfaces or are the same Ethernet interface.

Still referring to FIG. 4, BAS controller 12 is shown to include a processing circuit 404 including a processor 406 and memory 408. Processing circuit 404 may be communicably connected to BAS interface 409 and/or communications interface 407 such that processing circuit 404 and the various components thereof can send and receive data via interfaces 407, 409. Processor 406 can be implemented as a general-purpose processor, an application specific integrated circuit (ASIC), one or more field programmable gate arrays (FPGAs), a group of processing components, or other suitable electronic processing components.

Memory 408 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. Memory 408 may be or include volatile memory or non-volatile memory. Memory 408 may include database components, object code components, script components, or any other type of information structure for supporting the various activities and information structures described in the present application. According to an exemplary embodiment, memory 408 is communicably connected to processor 406 via processing circuit 404 and includes computer code for executing (e.g., by processing circuit 404 and/or processor 406) one or more processes described herein.

In some embodiments, BAS controller 12 is implemented within a single computer (e.g., one server, one housing, etc.). In various other embodiments, BAS controller 12 may be distributed across multiple servers or computers (e.g., that can exist in distributed locations). Further, while FIG. 4 shows applications 422 and 426 as existing outside of BAS controller 12, in some embodiments, applications 422 and 426 may be hosted within BAS controller 12 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 may be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BAS 11.

Enterprise integration layer 410 may be configured to serve clients or local applications with information and services to support a variety of enterprise-level applications. For example, enterprise control applications 426 may be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BAS controller 12. In yet other embodiments, enterprise control applications 426 can work with layers 410-420 to optimize building performance (e.g., efficiency, energy use, comfort, or safety) based on inputs received at interface 407 and/or BAS interface 409.

Building subsystem integration layer 420 may be configured to manage communications between BAS controller 12 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 may be configured to optimize resource usage (e.g., electricity use, natural gas use, water use, etc.) and/or the monetary cost of such resource usage in response to satisfy the demand of building 10. The optimization may be based on time-of-use prices, curtailment signals, energy availability, or other data received from utility providers, distributed energy generation systems 424, from energy storage 427, or from other sources. Demand response layer 414 may receive inputs from other layers of BAS controller 12 (e.g., building subsystem integration layer 420, integrated control layer 418, etc.). The inputs received from other layers may include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to an exemplary embodiment, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models may include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions may be edited or adjusted by a user (e.g., via a graphical user interface) so that the control actions initiated in response to demand inputs may be tailored for the user's application, desired comfort level, particular building equipment, or based on other concerns. For example, the demand response policy definitions can specify which equipment may be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 may be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In an exemplary embodiment, integrated control layer 418 includes control logic that uses inputs and outputs from a plurality of building subsystems to provide greater comfort and energy savings relative to the comfort and energy savings that separate subsystems could provide alone. For example, integrated control layer 418 may be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 may be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 may be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 may be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 may be configured to provide calculated inputs (e.g., aggregations) to these higher levels based on outputs from more than one building subsystem.

Automated measurement and validation (AM&V) layer 412 may be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 may be based on building system energy models and/or equipment models for individual BAS devices or subsystems. For example, AM&V layer 412 may compare a model-predicted output with an actual output from building subsystems 428 to determine an accuracy of the model.

Fault detection and diagnostics (FDD) layer 416 may be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults may include providing an alert message to a user, a maintenance scheduling system, or a control algorithm configured to attempt to repair the fault or to work-around the fault.

FDD layer 416 may be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to an exemplary embodiment, FDD layer 416 (or a policy executed by an integrated control engine or business rules engine) may shut-down systems or direct control activities around faulty devices or systems to reduce energy waste, extend equipment life, or assure proper control response.

FDD layer 416 may be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BAS 11 and the various components thereof. The data generated by building subsystems 428 may include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### System for Generating Attribute Health Status Indicators and Overall Device Health Status Indicators for Building Devices

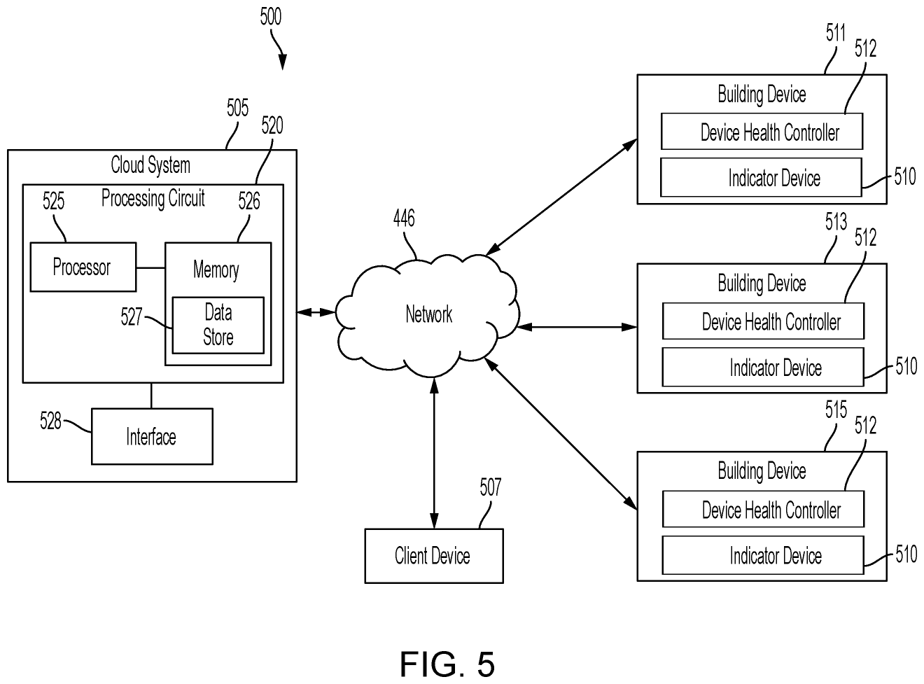

Referring to FIG. 5, a block diagram of a system 500 is shown, according to some embodiments. The system 500 may include and/or be implemented as at least one of the various systems described herein. For example, the system 500 may be implemented as the BAS 1111. In some embodiments, the system 500 may include at least one of the various systems and/or components described herein. In some embodiments, systems, components, and/or devices of the system 500 may be added, removed, integrated, combined, separated, rearranged, relocated, and/or replaced. For example, a device of the system 500 that may be shown to include two components may be modified such that the two components are combined into a single component. As another example, a component that is shown to be included in a first device may also be added to a second device. Each system or device in the system 500 may include one or more processors, memory devices, network interfaces, and user interfaces. The memory devices may store programming logic that, when executed by the processors, controls the operation of a corresponding computing system or device. The memory devices may also store data in databases.

In some embodiments, the system 500 includes at least one cloud system 505, the network 446, at least one client device 507, and one or more building devices, shown as building devices 511, 513, 515. In some embodiments, systems, devices, and/or components of the system 500 may be in communication with one another. Specifically, the cloud system 505, the client device 507, and/or the building devices 511, 513, 515 are communicatively coupled to the network 446 such that the network 446 permits the direct or indirect exchange of data, values, instructions, messages, and the like (represented by the double-headed arrows in FIG. 5). In some arrangements, the network 446 is configured to communicatively couple to additional computing system(s). In some embodiments, the communication includes wireless communication. For example, the communication may include communication via a Wireless Local Area network (WLAN), a cellular network, the Internet, Wi-Fi, Wi-Max, a proprietary provider network, a proprietary service provider network, and/or any other kind of wireless and/or wired network.

In some embodiments, the cloud system 505 may include at least one of servers, remote computing systems, a cloud-based system, remote databases, and/or other possible cloud computing systems. In some embodiments, the cloud system 505 may be distributed and/or implemented across one or more components. For example, the cloud system 505 may be distributed across one or more servers. In some embodiments, the cloud system 505 may be remote and/or external to the building 10. For example, the cloud system 505 may be housed separate from the building 10. In some embodiments, the cloud system 505 may be housed and/or located within the building 10. For example, the building 10 may include a server bank that houses and/or implements the cloud system 505.

In some embodiments, the cloud system 505 may include similar components to at least one of the various systems and/or devices described herein. For example, the cloud system 505 may include the BAS controller 12. In some embodiments, the cloud system 505 may perform operations similar to that of at least one component and/or device described herein. For example, the cloud system 505 may perform operations similar to that of the monitoring and reporting applications 422.

In some embodiments, the cloud system 505 includes at least one processing circuit 520 and at least one interface 528. In some embodiments, the processing circuit 520 may perform at least one of the various operations described herein. In some embodiments, the processing circuit 520 may include hardware and/or circuitry similar to at least one of the devices and/or the components described herein. The interface 528 may include at least one of a Human-Machine Interface (HMI), a communications interface, a network interface, a transmitter, an antenna, a receiver, and/or a transceiver. In some embodiments, the interface 528 may include at least one display device (e.g., a screen, a monitor, a Liquid Crystal Display (LCD) screen, a touch screen, an Input/Output (I/O) device, and/or other possible devices). In some embodiments, the interface 528 may communicate with at least one of the devices and/or components of the system 500. For example, the interface 528 may communicate with the client device 507. In some embodiments, processing circuit 520 may perform operations similar to that of the interface 528.

In some embodiments, the processing circuit 520 may include at least one processor 525 and at least one memory 526. In some embodiments, the processors 525 may include at least one of the various processors, hardware, and/or circuitry described herein. In some embodiments, memory 526 may include at least one of the various types of memory described herein. In some embodiments, memory 526 may store instructions (e.g., computer code, software, and/or firmware. In some embodiments, the processors 525 may perform at least one of the various operations described herein responsive to the processors 525 executing instructions stored in memory 526. In some embodiments, the memory 526 may include at least one data store 527. In some embodiments, the data stores 527 may refer to and/or include at least one of databases, records, data structures, data arrays, memory banks, data storage, data records, and/or a collection of data stored in and/or by the memory 526.

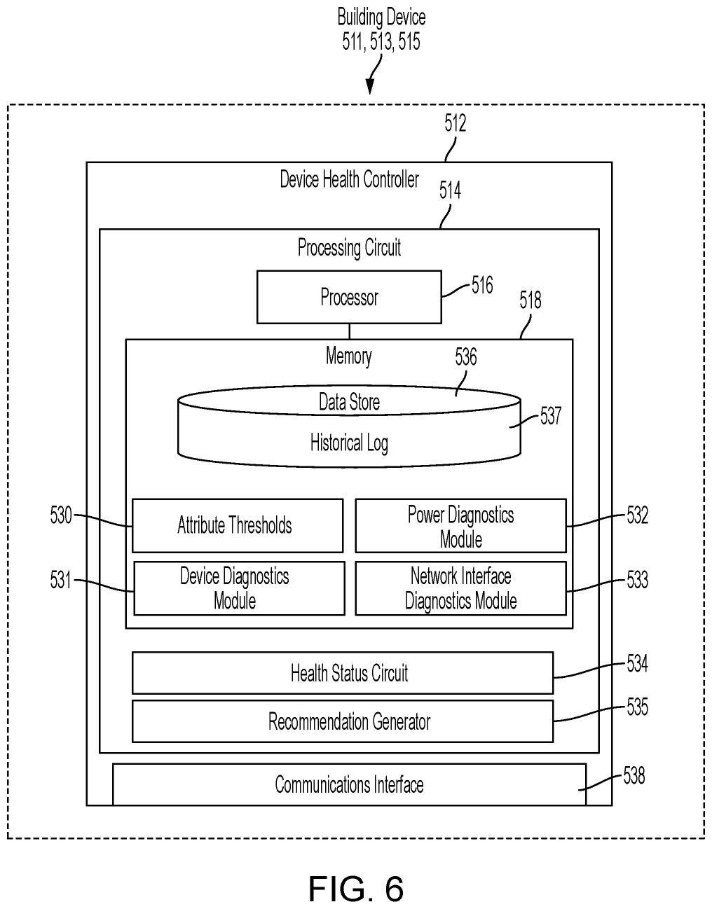

The building devices 511, 513, 515 can be or can include at least one of edge devices, data engines, controllers, data processors, digital signal processors, comparators, switches, routers, network devices, hubs, bridges, gateways, and/or other possible devices that may connect one or more devices to one another. In exemplary embodiments, the building devices 511, 513, 515 include various components such as a processor (e.g., a central processing unit (CPU)), one or more memory devices (e.g., random access memory (RAM), read-only memory (ROM), secondary storage, etc.), and a network interface (e.g., communications interface 538 shown in FIG. 6). The building devices 511, 513, 515 may connect the building 10 with the cloud system 505. For example, the building devices 511, 513, 515 may receive a first signal, from the building 10, and the building devices 511, 513, 515 may provide the first signal to the cloud system 505. In some embodiments, the building devices 511, 513, 515 may perform operations similar to at least one of the systems and/or devices described herein. The building devices 511, 513, 515 are shown to include a device heath controller 512. In exemplary embodiments, the building device health controllers 512 transmit building data and building device 513 health data to the cloud system 505.

As shown in FIG. 5, the building devices 511, 513, 515 include one or more indicator devices 510. The indicator devices 510 are structured to provide visual feedback regarding a status of the building device 511, 513, 515 or its components. The indicator devices 510 may be or include status lights, liquid crystal displays (LCDs), and/or audial alert devices.

Referring to FIG. 6, a block diagram of the device health controller 512 is shown, according to exemplary embodiments. As mentioned above, the device health controller 512 is disposed on the building devices 511, 513, 515. The device health controller 512 is shown to include a processing circuit 514, a processor 516, a memory 518, a communications interface 538, and one or more specialized processing circuits, shown as recommendation generator 535 and health status circuit 534.

The communications interface 538 is structured to receive communications from and provide communications to other computing devices, users, and the like associated with the building devices 511, 513, 515. The communications interface 538 may facilitate communications to the device health controller 512 and various external systems or devices. For example, the device health controller 512 may receive the monitored variables and/or attributes from a processor (e.g., the CPU), one or more memory devices (e.g., RAM, ROM, secondary storage), various drivers, applications, or other software stored on the memory devices, of the building devices 511, 513, 515. The communications interface 538 may provide control signals, performance indices, and/or other information of detected faults to the building devices 511, 513, and 515. The communications interface 538 may also be used to communicate with remote systems and applications such as the cloud system 505, the client device 507, and/or any other external system or device. For example, the device health controller 512 may provide performance indices and other information of detected faults associated with the building devices 511, 513, 515 to the cloud system 505, client device 507, or any other external system or device via communications interface 538.

The communications interface 538 can include any number and/or type of wired or wireless communications interfaces (e.g., jacks, antennas, transmitters, receivers, transceivers, wire terminals, etc.). For example, the communications interface 538 can include an Ethernet card and port for sending and receiving data via an Ethernet-based communications link or network. As another example, the communications interface 538 can include a WiFi transceiver, an NFC transceiver, a cellular transceiver, a mobile phone transceiver, or the like for communicating via a wireless communications network. In some embodiments, the communications interface 538 includes RS232 and/or RS485 circuitry for communicating with BMS devices (e.g., chillers, controllers, etc.). The communications interface 538 can be configured to use any of a variety of communications protocols (e.g., BACNet, Modbus, N2, MSTP, Zigbee, etc.). Communications via interface 538 can be direct (e.g., local wired or wireless communications) or via an intermediate communications network 446 (e.g., a WAN, the Internet, a cellular network, etc.). The communications interface 538 can be communicably connected with the processing circuit 514, and the various components thereof can send and receive data via the communications interface 538.

The processing circuit 514 is shown to include a processor 516 and memory 518. The processor 516 can be implemented as a general purpose processor, an application specific integrated circuit (ASIC), one or more field programmable gate arrays (FPGAs), a group of processing components, or other suitable electronic processing components. The memory 518 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. The memory 518 can be or can include volatile memory or non-volatile memory. The memory 518 can include database components, object code components, script components, or any other type of information structure for supporting the various activities and information structures described in the present application. According to some embodiments, the memory 518 is communicably connected to the processor 516 via the processing circuit 514 and includes computer code for executing (e.g., by processing circuit 514 and/or processor 516) one or more processes described herein.

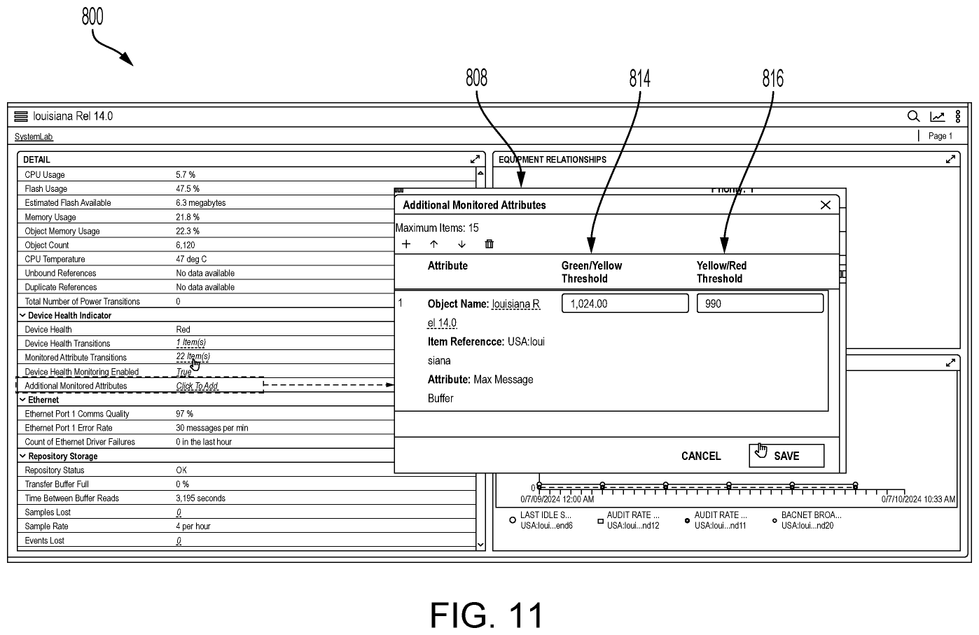

Referring still to FIG. 6, in some embodiments, the memory 518 includes a data store 536 having a historical log 537. The memory 518 can include a network interface diagnostics module 533, a power diagnostics module 531, attribute thresholds 530, and a device diagnostics module 531. In exemplary embodiments, the data store 536 stores a historical log 537 of device health statuses and data associated with changes in device health status. The memory 518 is shown to store attribute thresholds 530. In exemplary embodiments, the attribute thresholds 530 are status thresholds set by a user and/or a provider (e.g., as shown in FIG. 11). In other embodiments the attribute thresholds 530 are generated by the device health controller 512, for example, by applying machine learning model, using generative AI, or the like. By way of example, a user may operate a user interface displayed on the interface 528 of the cloud system 505 and/or on the client device 507 to input a set of transition threshold values for various attributes of the building devices 511, 513, 515 (e.g., as shown in FIG. 11). The thresholds may include a green/yellow threshold and a yellow/red threshold. A green status indicates that the building device 511, 513, 515 or a monitored attribute is operating within prescribed limits. In some examples, a yellow status indicates that the building device 511, 513, 515 or a monitored attribute exceeds the green/yellow threshold, which may lead to a problem or reduced performance. In other examples, a yellow status indicates that the building device 511, 513, 515 or a monitored attribute falls below a minimum green/yellow threshold value, which may lead to a problem or reduced performance. In some examples, a red status indicates that the building device 511, 513, 515 or a monitored attribute exceeds the yellow/red threshold which may result in negative user impact (e.g., loss of data, an offline condition, an alarm not being sent, etc.). In other examples, a red status indicates that the building device 511, 513, 515 or a monitored attribute falls below a minimum yellow/red threshold value, which may result in negative user impact. The historical log 537 stores each transition in status (e.g., each instance an attribute exceeds a threshold and the associated red/yellow/green status) for each monitored attribute. In exemplary embodiments, the historical log 537 includes data that may be associated with a transition in status, such as a time stamp and associated monitored attribute values. The historical log 537 may be transmitted to the cloud system 505. In exemplary embodiments, each instance of a transition in status may be accessed by a user on the interface 528 and/or the client device 507.

The device diagnostics module 531 may collect and store attribute data for the processor (e.g., the CPU), the memory (e.g., RAM, ROM, secondary storage), and the various drivers, applications, or other software stored thereon, of the building devices 511, 513, 515. By way of example, the device diagnostics module 531 may calculate device usage data and/or detect one or more events experienced by the hardware components of the building devices 511, 513, 515. For example, the device diagnostics module 531 may calculate CPU usage, memory 518 usage, flash usage, and/or object count (e.g., a number of active processes, tasks, or entities that the processor 516 is handling or managing at a given time). The device diagnostics module 531 may collect and consolidate additional data, such as CPU temperature, audit rate, transfer buffer rate, sample rate, and the like. By way of example, the device diagnostics module 531 may determine CPU usage as a percentage of active time (e.g., the time spent executing user applications and processes, time spent executing local processes, etc.) in view of total time (e.g., active time in addition to any idle time in which the CPU is not executing tasks). A user or provider may input (e.g., on the interface 528 of the cloud system 505) threshold values for the CPU usage. For example, the CPU usage attribute may indicate a green status when the CPU usage is 55% or less. If the CPU reaches 56%, the status transitions from green to yellow. If the CPU reaches 71% usage, the status transitions to a red status from either a green status or a yellow status. Accordingly, if the attribute is below a first threshold (e.g., green/yellow transition threshold, yellow/red transition threshold) associated with a first status at a first time, and above the first threshold (e.g., a usage value exceeds the first threshold, a number of events experienced exceeds the first threshold, etc.) at a second time, the device diagnostics module 531 determines that the building device 511, 513, 515 has transitioned from the first status to a second status.

The power diagnostics module 532 may collect and consolidate a total number of power transitions the building device 511, 513, 515 has experienced since last reset. A power transition is defined as a period during which the power supply to the building device 511, 513, 515 transitions between on and off. A user or provider may set a green/yellow threshold value and a yellow/red threshold value in terms of a total number of power transitions since last reset. In some embodiments, an alarm is triggered when the number of power transitions in a predetermined time (e.g., in 15 minutes, in an hour, in a day, etc.) exceeds the yellow/red threshold value.

The network interface diagnostics module 533 may determine, collect, and store various network communication data/attributes. For example, the network interface diagnostics module 533 may determine an ethernet communications quality. The ethernet communications quality includes values of consolidated transmission (TX) and receiving (RX) errors as a percentage of a total number of TX and RX messages exchanged. The ethernet communications quality may be calculated by the network interface diagnostics module 533 for each ethernet port, a single ethernet port, or a combination of two or more ethernet ports. Additionally or alternatively, the network interface diagnostics module 533 may calculate ethernet error rate for each ethernet port or a combination of two or more ethernet ports. The network interface diagnostics module 533 may determine ethernet error rate as time-based average of the rate of ethernet errors per ethernet port. The network interface diagnostics module 533 may also calculate a count of ethernet driver failures. The ethernet driver failure rate represents the number of transitions (e.g., “up,” or “down”) in a predetermined amount of time (e.g., the past hour). For each of the ethernet communications quality, the ethernet error rate, and the ethernet driver failure rate, a user or provider may set a green/yellow transition threshold value and a yellow/red transition threshold value. For example, the ethernet communication quality attribute may indicate a green status when the communication quality is 95% or more. If the communication quality falls to 94%, then the status transitions from green to yellow. If the communication quality falls to 84% or less, then the status transitions to a red status from either a green status or a yellow status.

Referring still to FIG. 6, the processing circuit 514 includes specialized the health status circuit 534 and the recommendation generator 535. In exemplary embodiments, the health status circuit 534 utilizes the attribute thresholds 530 and the various attribute data collected and consolidated by the device diagnostics module 531, the power diagnostics module 532, and the network interface diagnostics module 533, to determine statuses/status indicators for each attribute of the building devices 511, 513, 515. The health status circuit 534 may, for example, determine the status (e.g., red, yellow, or green) of each attribute that has a status threshold (e.g., green/yellow, yellow/red, green/red, etc.). The health status circuit 534 may aggregate a plurality of attributes to generate an overall health status of the building devices 511, 513, 515. The health status circuit 534 may, for example, determine overall health status using one or more of a statistical model, a machine learning model, a lookup table, by applying rules-based logic, etc. By way of example, a user or provider may define a set of rules by which overall health status of the building devices 51, 513, 515 is determined. For example, a user may input a “worst performing attribute” rule, which, in application, displays an overall device health consistent with the worst/riskiest status present out of all the attributes of a building device 511, 513, 515. In such a scenario, if the health status circuit 534 receives 24 device attributes with green statuses and one device attribute with a yellow status, the health status circuit 534 would generate an overall device health status of yellow. In some examples, the health status circuit 534 applies aggregated attribute rules to determine overall building device health. For example, a building device 511, 513, 515 may have a red status if the CPU temperature is 85° C. and the processor load is 75%. In other examples, the health status circuit 534 includes an algorithm that weighs a combination of attributes to determine an overall device health status. In such an example, the health status circuit 534 may apply a machine learning model that determines an overall device health status based on the current attribute data and status of each attribute. The overall device health status and/or the various attribute statuses are transmitted to the cloud system 505, such that they may be displayed on a user interface (e.g., as shown in FIGS. 8-10). In some examples, the building health controller 512 operates indicator devices 510 of the building devices 511, 513, 515, to indicate the overall health status (e.g., displaying a color corresponding to the overall health status, displaying a flashing pattern corresponding to the overall health status, etc.). Beneficially, the overall device health status can indicate the overall health of the building devices 511, 513, 515 at a given time and provide field technicians/diagnostic engineers the ability to pinpoint which building device is most critical to attend to. Beneficially, tracking attribute status and overall device health over time can draw attention to building devices that are consistently in poor health or that are trending in a negative direction, prompting branch service technicians to investigate.

The recommendation generator 535 may generate analyses of particular attribute status transitions or overall device health status transitions. Additionally or alternatively, the recommendation generator 535 may generate recommendations for altering the operation of a building device 511, 513, 515. In some examples, the recommendation is automatically implemented by the device health controller 512 as a part of an automated action to adjust operation of the building device 511, 513, 515 (e.g., the recommendation generator 535 may cause changes to the physical operation of the building devices). The recommendation may be, for example, a recommendation to end one or more active tasks or disable one or more programs to reduce the usage of one or more hardware components of the building device 511, 513, 515 (e.g., the CPU, the memory, etc.). As another example, the recommendation may be a recommendation to adjust buffer rate, cache size, or to adjust settings related to input/output operations to reduce a number of events, such as error events, experienced by the building device 511, 513, 515 (e.g., network interface communication errors, a number of failed communications between the building device 511, 513, 515 and another device, etc.). The recommendation may be a recommendation to update network related drivers to reduce communication failure rates. The recommendation may be a recommendation to execute an automated (e.g., self-healing) maintenance routine by the building devices 511, 513, 515 or to schedule manual maintenance for one or more components of the building device 511, 513, 515. In exemplary embodiments, the recommendations and/or analyses are transmitted to the cloud system 505, such that they may be displayed on a user interface.

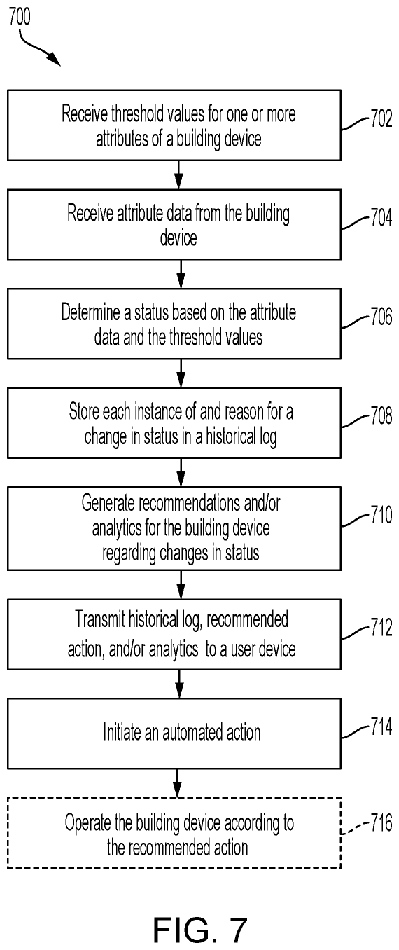

Referring now to FIG. 7, a flow chart for a process 700 for providing building device health statuses and analyses, according to exemplary embodiments. The process 700 can be executed by the device health controller 512, according to exemplary embodiments.

At step 702, the device health controller 512 receives threshold values for one or more attributes of a building device (e.g., the building devices 511, 513, 515). In exemplary embodiments, a user or provider inputs threshold values on a user interface (e.g., the interface 528 of the cloud system 505, via the client device 507, etc.), as shown, for example, in FIG. 11. The various thresholds may indicate a transition between a first status and a second status. For example, the thresholds may include a green/yellow transition threshold and a yellow/red transition threshold (e.g., the attribute thresholds 530). In some embodiments, a portion of the attribute thresholds are default thresholds that are preset by a provider. Additionally, or alternatively, a user may manually define some or all attribute thresholds.

At step 704, the device health controller 512 receives attribute data from the building device. In exemplary embodiments, the communications interface 538 receives attribute data from the building devices 511, 513, 515 and transmits the attribute data to the device health controller 512. The attribute data may include data related to the various devices disposed on the building device (e.g., the processor, memory, etc.), network data, and/or power transition data. In some examples, the device health controller 512 receives data regarding an attribute of the building device from a sensor, such as a temperature sensor. For example, the device health controller 512 may receive CPU temperature data from a temperature sensor disposed on or near the CPU of the building device 511, 513, 515.

At step 706, the device health controller 512 determines a status based on the received attribute data and threshold values. For example, the device heath controller 512 receives device health attribute data at various times (e.g., continuously, nearly continuously, every minute, every 15 minutes, hourly, etc.). For example, the device health controller 512 receives device health attribute data for one or more attributes of the building device and compares the device health attribute data to various thresholds (e.g., a first threshold, a second threshold, etc.). For example, if the device health attribute data crosses a first threshold, then the building device health controller 512 may determine that the building device 511, 513, 515 has transitioned from the first status to the second status. The various statuses are associated with predetermined health indicators. In exemplary embodiments, the statuses are green, yellow, or red; however, the statuses may be any suitable color, phrase, or symbol. By way of example, the device health controller 512 receives a green/yellow transition threshold of 55% CPU usage and a yellow/red transition threshold of 70% CPU usage. Continuing the example, the device health controller 512 receives data indicating that the CPU usage has increased from 45% to 60%. Responsive to determining this change in attribute value, the device health controller determines the current status of the CPU usage attribute is “yellow.” If the CPU usage continues to increase, for example, to 75%, the device health controller 512 determines the status of the CPU usage attribute is “red.”

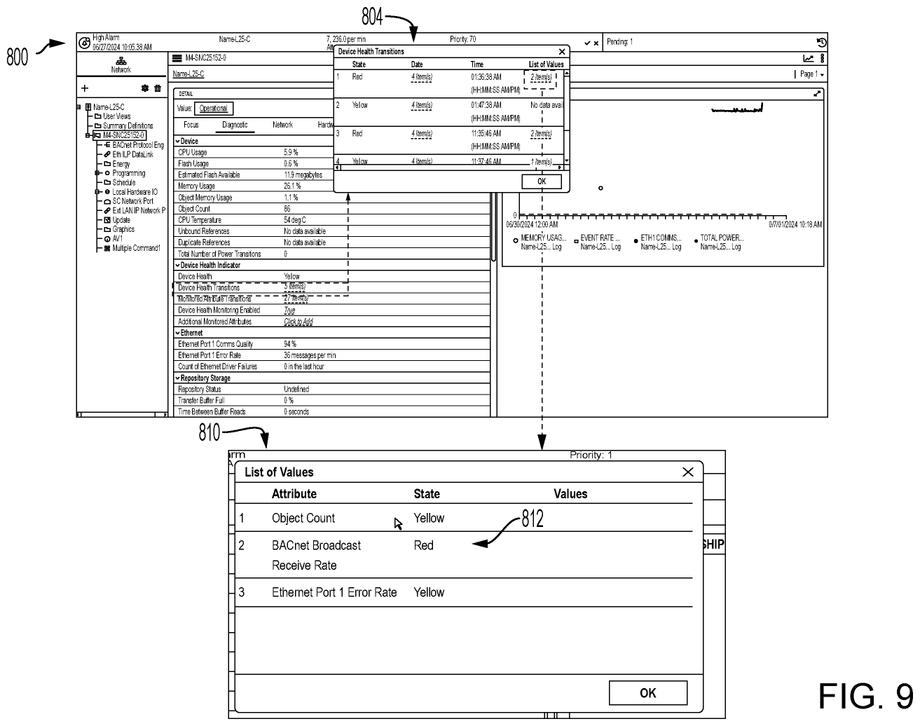

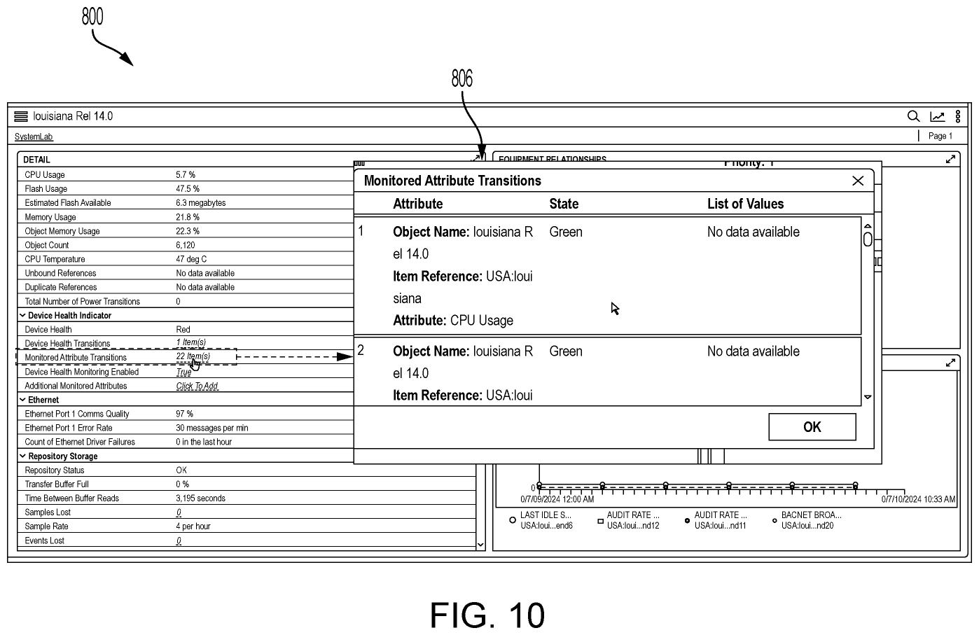

At step 708, the device health controller 512 stores each instance of a status transition in a historical log (e.g., the historical log 537). The historical log may include each instance of the overall device health transitions from one status to another, as well as each instance of the attribute status changing from one status to another. In some examples, the historical log stores data associated with the status transitions, such as the timestamp of the change and/or associated attribute data. For example, if the device health controller 512 determines that CPU usage has transitioned from green status to yellow status, the historical log may record the other attributes associated with the CPU and/or associated with the CPU's load at the time of the status transition (e.g., the CPU temperature, the object count, sample rate, etc.). In exemplary embodiments, the historical log is transmitted to and displayed on a user device (e.g., the interface 528, the client device 507, etc.) as a graphical user interface (e.g., as shown in the example of FIGS. 9 and 10).

At step 710, the device health controller 512 generates recommendations and/or analytics based on status transitions for overall building device health or status transitions for individual building device attributes. The device health controller 512 may analyze and generate reasoning for status transitions by applying a machine learning model, a rules-based analysis, a statistical model, a lookup table, or anything or the like. For example, the device health controller 512 may determine that a situation in which in which the CPU temperature is 85° C. and the processor load is 75% has a high probability (e.g., <70%) of the building device slowing down or spontaneously resetting. The device health controller 512 may further generate recommendations on how a user may bring the status of an attribute or the overall building device health below the green/yellow status threshold (e.g., into the range in which the building device and/or monitored attributes are operating within prescribed limits). For example, if the Ethernet communications quality is below a predefined threshold (e.g., in within the yellow status range or the red status range), the device health controller 512 may recommend that an operator inspect physical entities like LAN wires, Ethernet ports (CAT5/CAT6), for loose connections.

At step 712, the device health controller 512 transmits the historical log of status transitions to a remote computing device (e.g., the cloud system 505, the client device 507). In exemplary embodiments, the historical log is utilized by the cloud system 505 to generate a user interface (e.g., the interface 528). The user interface may be interactive, such that a user may view further details regarding the status transitions (e.g., the time stamp of the transition, associated attribute data, etc.) or may edit/create thresholds. The device health controller 512 may transmit the recommended actions and analytics to a remote computing device (e.g., the cloud system 505, the client device 507). In exemplary embodiments, the recommended actions and/or analyses regarding the status transitions are displayed on a user interface. The recommended actions may include one or more recommended steps for a user to follow to resolve an issue causing the change in status. In some embodiments, the user interface is interactive, such that a user may choose to implement the recommended actions.

At step 714, the device health controller 512 may initiate an automated action based on a transition from a first status to a second status (e.g., from a green status to a yellow status, from a yellow status to a red status, etc.). An automated action refers to a pre-defined response executed by the device health controller 512 without manual intervention when specific conditions or thresholds are met. For example, if the device health controller 512 identifies a status transition requiring attention, such as a transition from green status to yellow status, or from yellow status to red status, then the device health controller 512 may perform one or more automated actions. The automated actions may be based on the recommendations and/or reasons for the transitions generated at steps 708 and 710. The automated actions can be or include actions to reduce the usage of one or more components of the building devices 511, 513, 515 (e.g., the CPU, the memory, etc.) or to reduce a number of events experienced by the building device 511, 513, 515 (e.g., errors, communication failures, events lost, authentication failure, site director offline, undefined repository status, etc.). The automated actions may be or include adjusting system settings, terminating processes to reduce CPU load, updating software drivers, conducting diagnostic tests, or adjusting network configurations to rectify communication issues.

In some examples, the automated actions can be or include transmitting a notification of a change in status of an attribute to a user device (e.g., the interface 528, the client device 507). The notification (and any other notifications described herein) may be structured in a variety of formats, such as in the form of a push notification sent to a remote device (e.g., a user mobile device), a notification provided within a mobile application executed/running on a user device (e.g., smartphone) communicably coupled to the device health controller 512, a notification (e.g., pop-up message or corresponding light color) on a physical building device 511, 513, 515, a message displayed on a computer monitor linked to the device health controller 512, and/or some other form of notification methodology. In some examples, the automated action can be or include operating a user device or building device 511, 513, 515, to output an audible or audio-visual alarm. For example, responsive to the device health controller 512 detecting Ethernet communication qualities below a predefined green/yellow transition threshold or yellow/red transition threshold, the device health controller 512 may operate a user device and/or building device 511, 513, 515 to output “warning: Ethernet comm quality is low, check physical entities such as LAN wires and ETH ports (CAT5/CAT6) for loose connections.” The device health controller 512 may cause a user device to display one or more recommended steps for a user to follow to resolve an issue causing the change in status. For example, if a number of communication failures between a given building device 511, 513, 515 exceeds a predefined threshold (e.g., a green/yellow transition threshold, a yellow/red transition threshold, etc.) then the one or more recommended steps may include displaying “(i) inspect physical entities (e.g., LAN wires, ETH ports CAT5/CAT6, etc.) for loose connections, (ii) inspect a light status on the device, (iii) inspect whether IT technology switch is functioning properly by observing switch statistics and identifying discrepancies, (iv) validate whether other devices connected to the IT network switch have similar quantities of communication failures, and (v) scan the network for error network packets.” In some examples, the device health controller 512 operates a user device to display a first step of a series of steps (e.g., (i) inspect physical entities (e.g., LAN wires, ETH ports CAT5/CAT6, etc.) for loose connections) and prompts a user to select whether their issue was resolved before displaying a second step of the series of steps.

At optional step 716, the device health controller 512 operates the building device to implement the recommended actions automatically. For example, the device health controller 512 may terminate processes, update drivers, or perform a diagnostic test. Process 700 can thus result in changes to the physical operation of the building devices (e.g., building devices 511, 513, 515). In some examples, a user may opt-in to automatic implementation of recommended actions via a user interface (e.g., user interface 800 shown in FIGS. 8-11).

Referring to FIG. 8, a view of a user interface 800 is shown, according to exemplary embodiments. In some embodiments, the user interface 800 can be generated by the device health controller 512 and presented via a user device as a user interface. The user interface 800 is shown to include details regarding a single building device (e.g., building device 511, 513, or 515) in a details widget 801. The user interface 800 is shown to include a trend widget 805 that graphs attribute data trend lines of various attributes (e.g., audit rate, network broadcast rate, etc.). In some embodiments, the trend widget 805 shows a trend of overall device health status over time or a trend of one or more attribute statuses over time. The details widget 801 is shown to include various attribute data indicative of device health, such as the CPU usage, the flash usage, the memory usage, etc. The details widget 801 is further shown to include a section regarding repository storage attributes. Such data may correspond to the data collected and stored in the device diagnostics module 531 and the power diagnostics module 532 of FIG. 6. The user interface 800 is further shown to include an ethernet section that displays communication quality, error rate, and failure rate. Such data may correspond to the data collected and stored on the network interface diagnostics module 533.

The details widget 801 is shown to include a device health indicator section. The device health indicator section includes a device health status 802. As shown, the device health status 802 may be a phrase corresponding to the overall device health status generated by the health status circuit 534, such as “red,” “yellow,” or “green.” Although shown as “red,” “yellow,” or “green,” the status phrase may be any suitable phrase, such as “high risk,” “medium risk” or “low risk.” In some embodiments, the phrase indicative of the device health status 802 is color-coded (e.g., the phrase “red” is also red in color). Alternatively, or additionally, the device health status 802 may be a symbol, such as a color-coded shape (e.g., a red, yellow, or green circle). In other examples, the device health status 802 includes a symbol corresponding to each status. For example, a red X may indicate the red status, a yellow triangle may indicate a yellow status, and a green circle may indicate a green status.

The device health indicator section is shown to include user selectable options, including building device health transitions 804, monitored attribute transitions 806, and additional monitored attributes 808. Such features are explored in greater detail with respect to FIGS. 9-10. In some embodiments, a user may operate the user interface 800 to turn device health monitoring on or off.

Referring to FIG. 9, a graphical representation of a historical log of general/overall building device health transitions 804 is shown, according to exemplary embodiments. The log of building device health transitions 804 may be accessed by a user selecting “device health transitions” or a value displayed alongside “device health transitions” on the user interface 800. The building device health transitions 804 log is shown to include each instance the overall device health for a particular building device 511, 513, 515 transitioned from one status to another. In exemplary embodiments, the historical log 537 is the source of the building device health transitions 804 log. The device health controller 512 may transmit the historical log 537 in regular intervals (e.g., every minute, every five minutes, hourly, daily, etc.) or upon user request (e.g., when a user selects an option to view the log of building device health transitions 804). The log of building device health transitions 804 is shown to include a user selectable element/option to view more details regarding the values/attributes that caused the corresponding overall device health status. The list of values 810 is shown responsive to a user selecting a value displayed under the “list of values” column. The list of values 810 is shown to include a list of attribute statuses 812. In some embodiments, the list of values 810 includes a list of attributes, the current status of each attribute, the current value of the attribute, and/or the timestamp that each attribute transitioned to the current status. As discussed relative to the overall device health status 802, the statuses shown on the log of building device health transitions 804 and the list of values 810 may be phrases, color coded phrases, symbols, or anything of the like.

Referring to FIG. 10, a log of monitored attribute transitions 806 is shown, according to exemplary embodiments. The log of monitored attribute transitions 806 may be accessed by a user selecting “monitored attribute transitions” or a value displayed alongside “monitored attribute transitions.” In some embodiments, the monitored attribute transitions include a list of the monitored attributes, a log of transitions from one status to another, the current value of the attribute, and/or the timestamp that each attribute transitioned to the current status. As discussed relative to the device health status 802, the statuses shown on the log of building device health transitions 804 and the list of values 810 may be phrases, color coded phrases, symbols, or anything of the like.

Referring to FIG. 11, a widget for additional monitored attributes 808 is shown, according to exemplary embodiments. The widget for additional monitored attributes 808 may be accessed by a user selecting “additional monitored attributes” or a value displayed alongside “additional monitored attributes.” In the additional monitored attributes 808 widget, a user may enter threshold values for particular attributes of particular building devices (e.g., building devices 511, 513, 515). As discussed above, a user may enter some or all of the attribute thresholds utilized by device health controller 512. In some examples, a user may edit default thresholds set by a provider using the additional monitored attributes 808 widget. As shown in FIG. 11, a user may enter transition threshold values (e.g., a green/yellow threshold value 814, a yellow/red threshold value 816). In other examples, a user may enter ranges that coordinate to statuses. For example, a user may enter a range of values corresponding to a green status, a range of values corresponding to a yellow status, and/or a range of values corresponding to a red status in addition to or as an alternative to transition threshold values. In some examples, a user may additionally set a threshold value for an alarm to activate. Various user interfaces that may be transmitted and/or generated by the controller 512 to show attribute status, overall device health status, the history of attribute status transitions, the history of overall device health status transitions, etc. are described in greater detail in U.S. Provisional Patent Application No. 63/633,494 filed Apr. 12, 2024, U.S. patent application Ser. No. 18/087,117 filed Dec. 22, 2022, U.S. Pat. No. 10,281,363 filed Mar. 24, 2016, and U.S. Pat. No. 11,852,505 filed Aug. 20, 2021, the entire disclosure of each of which is incorporated by reference herein.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems, and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures show a specific order of method steps, the order of the steps may differ from what is depicted. Also, two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

What is claimed is:

1. A building device comprising:
a controller comprising one or more memory devices storing instructions thereon that, when executed by one or more processors, cause the one or more processors to:
compare attribute data for one or more attributes of the building device to a first threshold and a second threshold, the attribute data indicating a usage of one or more hardware components of the building device or a number of events experienced by the building device;
determine that the building device has transitioned from a first status to a second status in response to the attribute data crossing the first threshold or the second threshold;
generate one or more reasons for a transition from the first status to the second status by comparing the attribute data before crossing the first threshold or the second threshold with the attribute data after crossing the first threshold or the second threshold; and
initiate an automated action based on the one or more reasons for the transition to reduce the usage of the one or more hardware components of the building device or reduce the number of events experienced by the building device in response to determining that the building device has transitioned from the first status to the second status.

2. The building device of claim 1, wherein the one or more attributes comprise a plurality of attributes of the building device and the instructions cause the one or more processors to:
determine an attribute-specific status for each of the plurality of attributes based on the attribute data; and
determine an overall device health status based on the attribute-specific status for each of the plurality of attributes.

3. The building device of claim 2, further comprising an indicator device, wherein the automated action includes operating the indicator device to display a color corresponding to the attribute-specific status or the overall device health status.

4. The building device of claim 1, wherein the automated action includes:
determining a recommended action based on the one or more reasons for the transition from the first status to the second status; and
causing a user device to display the recommended action, the recommended action including one or more steps for a user to follow to reduce the usage of the one or more hardware components of the building device or reduce the number of events experienced by the building device.

5. The building device of claim 1, wherein the automated action includes:
determining a recommended action based on the one or more reasons for the transition from the first status to the second status; and
operating the building device according to the recommended action.

6. The building device of claim 1, wherein the one or more attributes of the building device include at least one of:
network communication data;
power transition data; or
device usage data.

7. The building device of claim 1, wherein the one or more attributes comprise a plurality of attributes of the building device and wherein the one or more reasons for the transition from the first status to the second status are determined based on identifying which attribute of the plurality of attributes experienced a change in attribute data resulting in the crossing of the first threshold or the second threshold.

8. The building device of claim 1, wherein the one or more reasons for the transition from the first status to the second status are determined based on whether the attribute data for the one or more attributes experienced a change in value resulting in crossing the first threshold or the second threshold.

9. The building device of claim 1, wherein the automated action includes causing a user device to display the one or more reasons for the transition from the first status to the second status.

10. The building device of claim 1, wherein the instructions cause the one or more processors to:
store an instance of the first status and of the second status on a historical log; and
generate a user interface including the historical log as a user selectable element, wherein selecting the historical log causes the user interface to display the instance of the first status and the instance of the second status.

11. The building device of claim 1, wherein the instructions cause the one or more processors to:
compare the attribute data to the first threshold, the second threshold, and a third threshold;
determine that the building device has transitioned from the first status or the second status to a third status in response to the attribute data crossing the third threshold; and
initiate an automated action in response to detecting a transition from the first status or the second status to the third status.

12. A building management system comprising:
one or more building devices; and
a controller comprising one or more memory devices storing instructions thereon that, when executed by one or more processors, cause the one or more processors to:
compare attribute data for one or more attributes of the one or more building devices to a first threshold and a second threshold, the attribute data indicating a usage of one or more hardware components of the one or more building devices or a number of events experienced by the one or more building devices;
determine that the one or more building devices have transitioned from a first status to a second status in response to the attribute data crossing the first threshold or the second threshold;
generate a historical log of transitions between the first status and the second status based on attribute data associated with the one or more building devices; and
cause a user device to display a user interface including one or more graphical representations of the historical log of transitions between the first status and the second status, the one or more graphical representations including user selectable elements.

13. The building management system of claim 12, wherein the one or more attributes comprise a plurality of attributes of the one or more building devices and the instructions cause the one or more processors to:
determine an attribute-specific status for each of the plurality of attributes based on the attribute data; and
determine an overall device health status based on the attribute-specific status for each of the plurality of attributes.

14. The building management system of claim 12, wherein the instructions cause the one or more processors to:
generate one or more reasons for a transition from the first status to the second status by comparing the attribute data before crossing the first threshold or the second threshold with the attribute data after crossing the first threshold or the second threshold; and
cause the user device to display the one or more reasons for the transitions from the first status to the second status.

15. The building management system of claim 14, wherein the one or more attributes comprise a plurality of attributes of the one or more building devices and wherein the one or more reasons for the transition from the first status to the second status are determined based on identifying which attribute of the plurality of attributes experienced a change in attribute data resulting in the crossing of the first threshold or the second threshold.

16. The building management system of claim 14, wherein the instructions cause the one or more processors to:
determine one or more recommended actions based on the one or more reasons for the transitions from the first status to the second status; and
cause a user device to display the one or more recommended actions, the one or more recommended actions including one or more steps for a user to follow to reduce the usage of the one or more hardware components of the one or more building devices or reduce the number of events experienced by the one or more building devices.

17. The building management system of claim 14, wherein the instructions cause the one or more processors to:
determine a recommended action based on the one or more reasons for the transitions from the first status to the second status; and
operate the one or more building devices according to the recommended action.

18. The building management system of claim 12, wherein the one or more attributes of the one or more building devices include at least one of:
network communication data;
power transition data; or
device usage data.

19. A method for dynamically updating and displaying attribute statuses associated with building devices of a building management system, comprising:
comparing attribute data for one or more attributes of a building device to a first threshold and a second threshold, the attribute data indicating a usage of one or more hardware components of the building device or a number of events experienced by the building device;
determining that the building device has transitioned from a first status to a second status in response to the attribute data crossing the first threshold or the second threshold;
generating one or more reasons for a transition from the first status to the second status by comparing the attribute data before crossing the first threshold or the second threshold with the attribute data after crossing the first threshold or the second threshold; and
initiating an automated action based on the one or more reasons for the transition to reduce the usage of the one or more hardware components of the building device or reduce the number of events experienced by the building device in response to determining that the building device has transitioned from the first status to the second status.

20. The method of claim 19, further comprising:
storing an instance of the first status and of the second status on a historical log; and
generating a user interface including the historical log as a user selectable element, wherein selecting the historical log causes the user interface to display the instance of the first status and the instance of the second status.
